(19) United States
(12) Patent Application Publication
(10) Pub. No.: US 2026/0156727 A1
(43) Pub. Date: Jun. 4, 2026

(54) LED POWER SUPPLY WITH ISOLATION FEEDBACK AND OVER CURRENT PROTECTION

(71) Applicant: LEDup Manufacturing Group Limited, City of Industry, CA (US)

(72) Inventor: Jing Jing Yu, City of Industry, CA (US)

(73) Assignee: LEDup Manufacturing Group Limited, City of Industry, CA (US)

(21) Appl. No.: 19/406,429

(22) Filed: Dec. 2, 2025

Related U.S. Application Data
(60) Provisional application No. 63/727,031, filed on Dec. 2, 2024.

(51) Int. Cl. H05B 45/56; H05B 47/25

(52) U.S. Cl. CPC H05B 45/56; H05B 47/25

(57) ABSTRACT

Disclosed is an isolation converter circuit that includes a safety circuit for protecting a fuse. A fuse and a thermistor are thermally coupled so that when the fuse increases in temperature, the thermistor changes current to a switch that shuts down the isolation converter circuit.

### BACKGROUND OF THE INVENTION

Lighting using light emitting diodes is a practical and inexpensive way to provide illumination for various purposes. The advantages of LED lighting are that LEDs operate effectively at low direct current voltages and currents. Further, LED lights produce a large number of lumens for the energy that LEDs consume. Moreover, LEDs do not generate a significant amount of heat, which renders LED lights a safer alternative to other forms of lighting.

### SUMMARY OF THE INVENTION

An embodiment of the present invention may therefore comprise an isolation converter circuit comprising: an alternating current (AC) input signal that is connected to a fuse; a rectifier that rectifies said AC input signal to produce a rectified signal; a low pass filter connected to said rectifier that connects said rectified signal to a direct current (DC) signal; a three winding transformer connected to said DC signal, having a primary coil, a secondary coil and a sensor coil; a controller circuit connected to said DC signal and said primary coil that periodically connects said primary coil to ground potential to modulate current on said primary coil in response to a sensor feedback control signal; a sensor feedback control line that is connected to said sensor coil that provides said sensor feedback control signal to said controller circuit; a switch connected to said feedback control signal line that connects said sensor feedback control line to ground potential to stop said controller circuit from modulating current on said primary coil; a thermistor that is thermally coupled to said fuse, said thermistor connected to said DC signal and to a control input of said switch so that when the temperature of said thermistor reaches a predetermined level, said switch is turned on and said control circuit stops modulating current on said primary coil and said isolation circuit is turned off before said fuse burns out.

An embodiment of the invention may further comprise a method of making an isolation converter circuit and protecting said isolation converter circuit from overcurrent conditions comprising connecting a fuse in an AC input power line; rectifying an AC signal provided by said AC input power line; filtering said AC signal to produce a DC signal; applying said DC signal to a first side of a primary coil of a three winding transformer having said primary coil, a secondary coil and a sensor coil; connecting a ground shunt line to a second side of said primary coil and to a controller; generating a sensor feedback control signal from said sensor coil of said three winding transformer; connecting said sensor feedback control signal to a feedback input of a controller using a sensor feedback control line; operating said controller to periodically shunt said second side of said primary coil to ground potential at a controlled frequency or controlled duration in response to said feedback control signal to control power transmitted by said primary coil to said secondary coil and said sensor coil of said three stage transformer; connecting a thermistor to a DC voltage supply and input control of a switch; connecting said sensor feedback control line to ground potential when said switch is turned on; thermally coupling said fuse and said thermistor to allow said fuse to thermally conduct heat to said thermistor which allows said thermistor to conduct a sufficient amount of current to turn on said switch before said fuse burns

### BRIEF DESCRIPTION OF THE DRAWINGS

FIG. 1 is a schematic block diagram of an embodiment of an isolation converter circuit of the present invention.

FIG. 2 is a schematic diagram of an isolation converter circuit of the present invention.

FIG. 3 is an embodiment of a manner of coupling a thermistor and fuse.

FIG. 4 is another embodiment of a manner of coupling a thermistor and fuse.

FIG. 5 is another embodiment of a manner of coupling a thermistor and fuse.

### DETAILED DESCRIPTION OF THE EMBODIMENTS

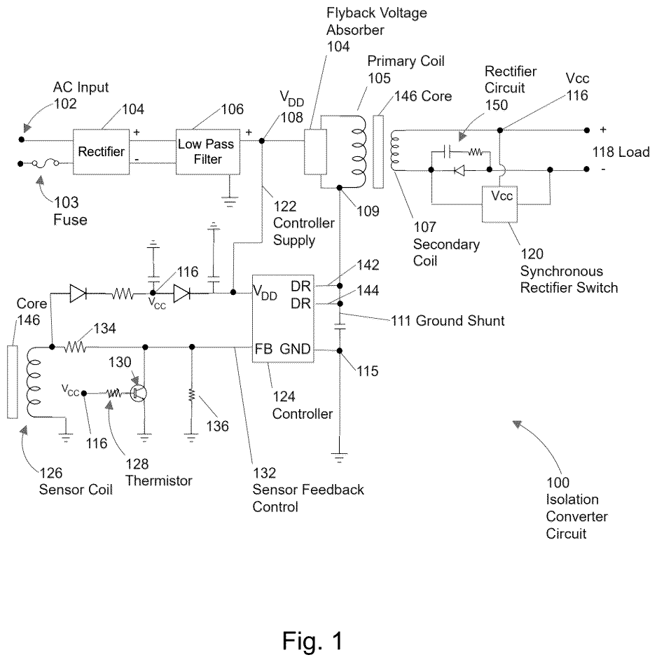

FIG. 1 is a schematic block diagram of an embodiment of an isolation converter circuit 100. An AC input 102 provides an AC input signal to a rectifier 104. For example, standard 60 cycle, 117 volt, RMS wall current can be applied to the AC input 102. Fuse 103 protects the isolation converter circuit 100 from overcurrent and burnout. Rectifier 104 may comprise a full-wave rectifier such as a Wheatstone bridge with a positive and negative output. Low pass filter 106 receives the full-wave rectified signal from rectifier 104 and produces a DC output at node 108. The positive DC signal at node 108 is applied to a transformer comprising a primary coil 105, a secondary coil 107, a sensor coil 126 and a core 146. A flyback voltage absorber 114 is connected across the primary coil to absorb voltage fluctuations in the primary coil 105. The secondary coil 107 is hooked to an output load 118 which comprises a DC load such as an LED light string. Of course, other DC loads can be powered by the isolation converter circuit 100. The bottom of the primary coil 105 has a connection at node 109 to ground shunt 111. Controller 124 is connected to node 108 via controller supply 122 to provide supply voltage V_{DD} to the controller 124. The controller 124 periodically shunts Node 108 to ground potential at Node 115 using the ground shunt 111 and control ports 142, 144. A sensor feedback control signal 132 controls the frequency and/or duration of the ground shunt.

Secondary coil 107 receives the modulated signal from the primary coil 105. The modulated signal on secondary coil 107 is rectified by rectifier circuit 150. A synchronous rectifier switch 120 is connected across the rectifier circuit 150 to reduce power consumption of the rectifier circuit 150. The synchronous rectifier switch 120 essentially works by eliminating power loss as a result of the voltage over across the diode in the rectifier circuit 150.

An operation, sensor coil 126 senses feedback provided by the secondary coil 107 to the transformer from the demand of the load 118. In other words, if a voltage on the primary coil 105 is reduced, voltage on the secondary coil 107 and sensor coil 126 is also reduced. The lower voltage on sensor coil 126 is supplied to the feedback input of controller 124 at via feedback control 132. Sensor feedback control 132 is the voltage between the resistor divider circuit comprising resistor 134 and resistor 136. The sensor feedback control 132 provides a voltage level to the feedback input (FB) of controller 124 that controls the duty cycle/frequency of the ground shunt 111. The duty cycle/frequency of the ground shunt 111 controls the voltage on the primary coil 105 which is transmitted across the core 146 to the secondary coil 107 and the sensor coil 126. The voltage on the sensor feedback control is the voltage on the sensor coil 126 that is reduced by the voltage divider circuit comprising resistor 134 and resistor 136. Therefore, the voltage at the feedback input of controller 124 is a specified percentage of the voltage on the primary coil 105. Controller 124 includes a comparator circuit that compares the feedback voltage from sensor feedback control 132 to the controller supply voltage 122 (V_{DD}) and adjusts the duty cycle that is controlled by the ground shunt 111. If the voltage at the sensor feedback control 132 is reduced as a result of the sensor coil 126 having a reduced voltage, the controller 124 increases the duty cycle of the controller 124 so that primary coil 105 delivers a higher average voltage across the core 146 to secondary coil 107 and sensor coil 126.

FIG. 1 also illustrates a thermistor 128 that has a negative temperature coefficient. As a result, as the thermistor 128 increases in temperature, the resistance of the thermistor goes down. The input of the thermistor 128 is a voltage V_{CC} at node 116. If thermistor 128 increases in temperature, more current is supplied to the base of switch 130. When the resistance of thermistor 128 is reduced sufficiently, switch 130 is turned on and the voltage on sensor feedback control 132 is reduced to ground potential. When the sensor feedback control 132 has a voltage of zero, controller 124 no longer grounds the primary coil 105 so that the primary coil 105 does not transmit an AC voltage across the core 146 to the secondary coil 107 and sensor coil 126. In other words, the isolation converter circuit 100 shuts down.

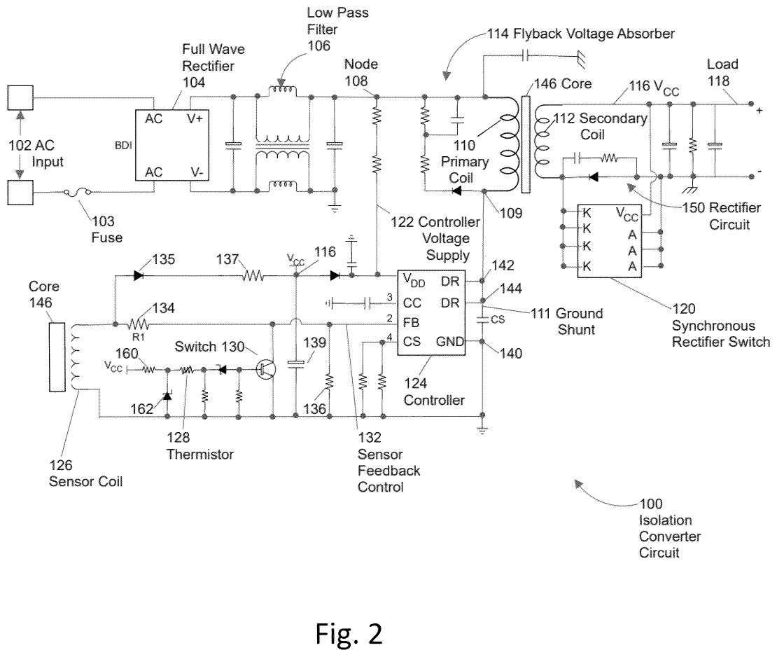

The circuit in FIG. 1 uses a fuse 103 as a safety measure to prevent an overcurrent situation which may create a safety concern, such as an electrical fire. Fuse 103 is required to meet safety standards. Fuse 103 may be difficult or impossible to replace. A resettable breaker in an isolation converter circuit 100 would be cost prohibitive. The circuit, as designed and illustrated in FIGS. 1 and 2 can operate reliably and with a very low probability of burning out the fuse 103. However, some users plug the isolation converter circuit 100 into a dimmer device which can adversely affect the operation of the isolation converter circuit 100 and cause the fuse 103 to burnout as a result of the wave forms created by the dimmer devices. Dimmer devices typically operate by modulating a standard AC power input and/or varying the duty cycle of the standard AC input. Clipped or modulated signals may interact with the shunt control provided by the controller 124 and create adverse wave forms that affect the sensor feedback control voltage 132 and cause the controller 124 to incorrectly create ground shunt signals 111 that draw excessive current through the primary coil 105 which can burn out the fuse 103. If the fuse 103 is burned out, in most cases, the circuit is dead and cannot be reused since the fuse 103 is not replaceable. Essentially, a dimmer switch connected to the AC input 102 causes the power delivered to the primary coil 105 to be reduced. Sensor coil 126 detects the lower power on the primary coil 105 and provides a sensor feedback control signal 132 that instructs the controller 124 to create a higher duty cycle signal at the primary coil 105. This causes an excessive current to be drawn through the fuse 103 which then burns out the fuse 103. For this reason, the thermistor 128 is used to shut down the sensor feedback control signal 132 whenever the fuse 103 begins to increase in temperature as a result of excess current flowing through the fuse 103.

FIG. 2 is a more detailed illustration of the isolation converter circuit 100. As illustrated in FIG. 2, the AC input 102 is provided and may comprise standard wall power such as 100 17-volt RMS power or other supply power. The AC power is supplied to a full-wave rectifier 104 such as a Wheatstone bridge. The rectified voltage is sent through a low pass filter 106 to node 108. Node 108 is connected to the controller voltage supply 122 and to a flyback voltage absorber 114 that absorbs flyback voltages from the transformer comprising primary coil 110, secondary coil 112, core 146 and sensor coil 126. The secondary coil 112 is connected to a rectifier supplier circuit 150 and a synchronous rectifier switch 120. The rectified voltage is smoothed and provided at output 118, which is connected to a load, such as a light string or light source. The synchronous rectifier switch 120 reduces the power consumption of the rectifier circuit 150. The controller voltage supply 122 is connected to the voltage input (V_{DD}) of controller 124. Controller 124 includes a ground shunt 111 which is connected to node 109.

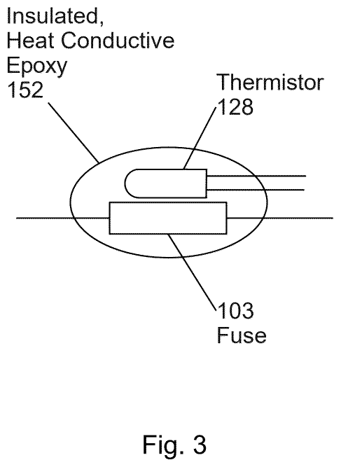

FIG. 2 also illustrates sensor coil 126. Sensor coil 126 is connected to diode 135 which rectifies the voltage of coil 146. The rectified voltage is smoothed by resistor 137 and capacitor 139, to obtain a voltage V_{CC} at node 116. V_{CC} is applied to resistor 160 and Zener diode 162 to control the voltage at the input of thermistor 128. Zener diode 164 controls the voltage at the input (base) of switch 130. Switch 130, when turned on grounds the feedback input on sensor feedback control 132 to turn off the isolation converter circuit, 100. This occurs when the thermistor 128 has a reduced resistance sufficient to supply current to switch 130 as a result of the thermistor becoming hotter, as a result of heat provided by the fuse 103, as explained in more detail in FIG. 3.

FIG. 3 is one implementation of the manner in which the fuse 103 and the thermistor 128 can be thermally coupled so that heat created by the fuse 103 can be transferred to the thermistor 128 to cause a change in resistance of the thermistor 128. In the implementation shown in FIG. 3 an insulated, heat conductive epoxy 152 is utilized which holds the fuse 103 and thermistor 128 in tight proximity and allows heat to flow from the fuse 103 to the thermistor 128 in a very controlled and predictable manner. The sizes of the resistors and Zener diodes can be adjusted in the circuit illustrated in FIG. 2 to account for variations in the manner in which heat is transferred between the fuse 103 and thermistor 128 in the epoxy. The epoxy is an insulated epoxy which does not conduct electricity but has high heat conductivity. By fixing the position between the fuse and the thermistor using an epoxy, precise and predictable results can be achieved in the use of this protective circuit. Also, any manner of securing the thermistor and fuse together can be used to transfer heat from the fuse to the thermistor.

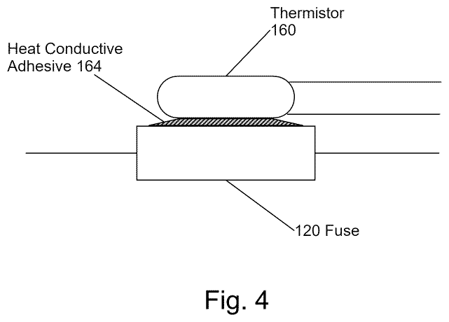

FIG. 4 is a schematic illustration of another embodiment for coupling the thermistor 160 and fuse 162. As shown in FIG. 4, a heat conductive adhesive 164 can be used to adhesively bond the thermistor 160 and fuse 162. Any type of adhesive for holding the thermistor 160 and fuse 162 together can be used. If the adhesive is sufficiently thin, the heat conductivity of the adhesive can be reduced and can be reduced even to zero if the thermistor 160 and fuse 162 are sufficiently close.

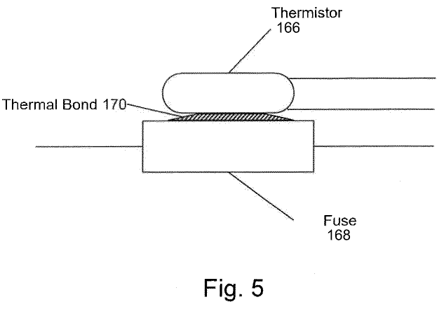

FIG. 5 is a schematic diagram of another embodiment for coupling a thermistor 166 and a fuse 168. As illustrated in FIG. 5, thermal bond 170 is used which directly couples the thermistor 166 to the fuse 168. The materials of either or both the thermistor 166 and fuse 168 can be selected to provide a thermal bond upon heating. Heating can be created in various was such as by IR radiation, sonic waves or any known method of heating thermally bonded materials.

The present invention therefore provides a reliable and predictable safety circuit that protects the isolation converter circuit 100 from fuse burnout due to the use of dimmer devices and other inputs that could cause the circuit to become inoperative.

The foregoing description of the invention has been presented for purposes of illustration and description. It is not intended to be exhaustive or to limit the invention to the precise form disclosed, and other modifications and variations may be possible in light of the above teachings. The embodiments were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. An isolation converter circuit comprising:
an alternating current (AC) input signal that is connected to a fuse;
a rectifier that rectifies said AC input signal to produce a rectified signal;
a low pass filter connected to said rectifier that connects said rectified signal to a direct current (DC) signal;
a three winding transformer connected to said DC signal, having a primary coil, a secondary coil and a sensor coil;
a controller circuit connected to said DC signal and said primary coil that periodically connects said primary coil to ground potential to modulate current on said primary coil in response to a sensor feedback control signal;
a sensor feedback control line that is connected to said sensor coil that provides said sensor feedback control signal to said controller circuit;
a switch connected to said feedback control signal line that connects said sensor feedback control line to ground potential to stop said controller circuit from modulating current on said primary coil when said switch is turned on;
a thermistor that is thermally coupled to said fuse, said thermistor further connected to said DC signal and to a control input of said switch so that when a temperature level of said thermistor reaches a predetermined level, said switch is turned on and said control circuit stops modulating current on said primary coil and said isolation circuit is turned off before said fuse burns out.

2. The isolation converter circuit of claim 1 wherein said thermistor has a negative temperature coefficient so that as said thermistor becomes hotter, the resistance of said thermistor is reduced.

3. The isolation converter circuit of claim 2 further comprising;
a rectifier circuit and low pass filter connected to said secondary coil that provides a DC output load signal.

4. The isolation converter circuit of claim 3 wherein said controller circuit includes a comparator circuit that compares said sensor feedback control signal with a set voltage to control said modulation of said current on said primary coil.

5. The isolation converter circuit of claim 4 wherein said thermistor and said fuse are thermally coupled with a nonconductive, heat transmissive epoxy.

6. The isolation converter circuit of claim 4 wherein said thermistor and said fuse are thermally coupled by bonding said thermistor and said fuse with a nonconductive, heat transmissive epoxy.

7. The isolation converter circuit of claim 4 wherein said thermistor and said fuse are thermally coupled with a nonconductive, heat transmissive epoxy by adhesively bonding said fuse and said thermistor using a heat conductive adhesive.

8. A method of making an isolation converter circuit and protecting said isolation converter circuit from overcurrent conditions comprising:
connecting a fuse in an AC input power line;
rectifying an AC signal provided by said AC input power line;
filtering said AC signal to produce a DC signal;
applying said DC signal to a first side of a primary coil of a three winding transformer having said primary coil, a secondary coil and a sensor coil;
connecting a ground shunt line to a second side of said primary coil and to a controller;
generating a sensor feedback control signal from said sensor coil of said three winding transformer;
connecting said sensor feedback control signal to a feedback input of a controller using a sensor feedback control line;
operating said controller to periodically shunt said second side of said primary coil to ground potential at a controlled frequency or controlled duration in response to said feedback control signal to control power transmitted by said primary coil to said secondary coil and said sensor coil of said three stage transformer;
connecting a thermistor to a DC voltage supply and input control of a switch;
connecting said sensor feedback control line to ground potential when said switch is turned on;
thermally coupling said fuse and said thermistor to allow said fuse to thermally conduct heat to said thermistor which allows said thermistor to conduct a sufficient amount of current to turn on said switch before said fuse burns out.

9. The method of claim 8 wherein said method of thermally coupling said fuse and said thermistor comprises:
surrounding said fuse and said thermistor with a nonconductive, heat transmissive epoxy.

10. The method of claim 8 wherein said method of thermally coupling said fuse and said thermistor comprises:
bonding said fuse and said thermistor.

11. The method of claim 10 wherein said method of bonding said fuse and said thermistor comprises:
adhesively bonding said fuse and said thermistor using a heat conductive adhesive.

12. The method of claim 10 wherein said method of bonding said fuse and said thermistor comprises:
thermally bonding said fuse and thermistor.

13. The method of claim 8 wherein said thermistor has a negative temperature coefficient so that when a temperature level of said thermistor reaches a predetermined level, sufficient current flows through said thermistor to term on said switch.

14. The method of claim 8 further comprising:
comparing said sensor feedback control signal with a specified voltage to create said controlled frequency or said controlled duration.
